(19) United States
(12) Patent Application Publication
(10) Pub. No.: US 2021/0112920 A1
(43) Pub. Date: Apr. 22, 2021

(54) ORTHOTIC SOLE AND INSOLE DEVICES, SYSTEMS, METHODS, AND COMPUTER READABLE MEDIA FOR USE WITH HIGH HEEL FOOTWEAR

(71) Applicant: ALIGN ORTHOTICS INC., Mississauga (CA)

(72) Inventors: Teressa DINSHAW, Mississauga (CA); Darius DINSHAW, Mississauga (CA)

(21) Appl. No.: 17/073,266

(22) Filed: Oct. 16, 2020

Related U.S. Application Data
(60) Provisional application No. 62/915,981, filed on Oct. 16, 2019.

(51) Int. Cl. A43B 17/14; B29C 64/386; B33Y 10/00; B33Y 50/00; B33Y 80/00

(52) U.S. Cl. CPC A43B 17/14; B29C 64/386; B29L 2031/507; B33Y 50/00; B33Y 80/00; B33Y 10/00

(57) ABSTRACT

Orthotic sole devices, systems, methods, and computer readable media are for use with footwear. Three-dimensional scans are used to shape the devices to match the user's feet with the footwear. Each of the devices includes a sunken heel portion, a stopper portion, an arch portion, metatarsal pads, a bunion-cut out shape, and a built-in toe crest portion, all to help redistribute the user's weight away from their forefoot. The devices are infused with eucalyptus oils and silver ions. The devices are automatically manufactured via computer numerical control (“CNC”) software on a computer readable medium. Milling machines and 3D printers can be used in association with the systems, methods, and computer readable media.

### FIELD OF THE INVENTION

The present invention relates generally to orthotic insoles and footwear and, more particularly, to orthotic sole and insole devices, systems, methods, and computer readable media for use with high heel footwear.

### BACKGROUND OF THE INVENTION

It may be desirable to make high heel shoes and other footwear more comfortable, by redistributing weight and/or improving foot posture within the footwear, using an orthotic sole or insole device.

In the prior art, there may have been a number of gimmicks which may have promised but afforded little or no functionality in this respect. Many such gimmicks, including off-the-shelf ones offered at drug stores and elsewhere, may have failed to consider or incorporate a medical assessment component relating, for example, to particular individual users' biomechanics, foot type, unique foot anatomy, and/or medical histories.

Some prior art shoe inserts may have afforded some help but, notwithstanding claims to the contrary, may have failed to effectively help stop the user's foot from sliding forward. Such inserts may have been provided with a toe crest that did not work with certain types of shoes, such as those with front straps and those with insufficient room in toe box portions thereof. Such inserts also may have failed to shift the user's weight to the back of their heel and away from their forefoot.

Similarly, other prior art insoles may have been formed from a clear resin material. While such insoles were designed in an effort to slow the user's foot from falling forward in their shoe, they may have failed to splay the user's toes, lift their metatarsal heads, adequately and accurately support their arches (e.g., the medial longitudinal arch, transverse arch, and lateral longitudinal arch), unload high pressure areas of their foot, and/or redistribute the user's weight.

These and other inserts and insoles may have also suffered from a further limitation in that their intended design was for permanent placement into the user's shoes, without affording the user with any ability to move them over to their other shoes.

Reinforced heel orthotic inserts may have been known in the prior art. They may have been designed to reduce impact at the heel, referencing the calcaneus or heel bone. In this respect, they may have substantially nothing to do with, and/or may be completely different than, the present invention.

Other high heel shoe devices of limited comfort may have been known in the prior art. While they may have been designed for use as (or with) high heels, they may have failed to afford sufficient comfort and/or a ready ability to conform to the shape of the user's shoe pitch and/or slope line, for example, to accommodate minor nuances. The shape of such devices may not have been designed and/or matched to the user's heel pitch and/or slope line. Heel pitch refers to the angle of the midsole from the heel to the flexpoint of the shoe, typically measured in degrees. Slope line refers to the curvature observed of the midsole from heel to flexpoint of the shoe. They also may have failed to afford sufficient space for the user's first metatarsal joint, which typically may be enlarged; and/or they may have failed to provide a cutout for the user's first metatarsal-phalangeal joint that effectively assists in mechanical loading through the forefoot.

What may be needed are orthotic sole and/or insole devices, systems, methods, and/or computer readable media for use with high heel footwear. (For example, computer readable media may be needed or desired to record—and/or, operatively, to encode one or more computer processors to help implement or perform—one or more features, inter-workings, and/or steps that are depicted or discussed herein in the context of the devices, systems, and/or methods according to the invention.)

It may be desirable and/or beneficial to provide an orthotic sole and/or insole device, system, method, and/or computer readable medium for use with high heel footwear.

It may be an object according to one aspect of the invention to provide an orthotic sole and/or insole device, system, method, and/or computer readable medium for use with high heel footwear.

It is an object of the present invention to obviate or mitigate one or more disadvantages and/or shortcomings associated with the prior art, to meet or provide for one or more desires, benefits, needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there are disclosed orthotic sole and/or insole devices, systems, methods, and/or computer readable media, designed by a certified pedorthoist (or other footcare specialist specifically trained in biomechanics, orthotic design, and orthotic manufacturing), for use with high heel footwear, which may preferably (but need not necessarily) involve one or more medical assessment components including, for example, as follow: (a) the user's total body alignment (posture and gait analysis); (b) whether the user may have a leg length discrepancy; (c) whether the user may have a limited range of motion; (d) whether the user may have a pelvic tilt; (e) whether the user may have some other reason not to change the body's natural position into a high heel at all; and/or (f) a substantially precise and/or measured degree to which the user may be misaligned.

According to one aspect of the invention, the devices, systems, methods, and/or computer readable media may preferably, but need not necessarily, include and/or provide for one or more three-dimensional (“3D”) scans of the user's feet and/or of the high heels to be fitted, preferably to match the unique anatomy of such user feet to the slope line and pitch of their footwear that the heel orthotic is being designed for.

According to one aspect of the invention, the sole and/or insole may preferably, but need not necessarily, be automatically milled via computer numerical control (“CNC”) software on a computer readable medium operatively connected to the milling machine and/or 3D printed to match the user's feet and/or the high heels to be fitted.

According to one aspect of the invention, the sole and/or insole may preferably, but need not necessarily, be adapted to fit a wide range of feet and/or high heels off-the-shelf.

According to one aspect of the invention, the devices, systems, methods, and/or computer readable media may preferably, but need not necessarily, provide for redistribution of the user's weight away from the forefoot by combination of one or more of the following mechanisms: (1) a sunken heel portion, which may preferably help to counter-shift the user's weight backwards and/or realign the user's heel; (2) a ‘stopper’ portion, substantially adjacent to and/or after the heel cup portion, which may preferably grab and/or otherwise engage the user's calcaneus and/or help to stop it from sliding down towards a toe area of the footwear; (3) an arch portion, which may preferably be bumped up to the correct degree, preferably to help stabilize the user's foot posture in their footwear and/or afford added reinforcement to help stop the user's foot from sliding downward in the footwear; (4) metatarsal pads, which may preferably be made to a precise height and/or durometer (or hardness), preferably to support the user's weight and/or shift the user's metatarsal heads where needed and/or desired, preferably to provide the user's toes with a healthy splay; (5) a unique bunion-cut out shape, which may preferably help to offload the bunion area of the user's foot, preferably helping to reduce pressure on the user's forefoot area; and/or (6) a built-in toe crest portion, which may preferably help to space and/or divide the user's toes, preferably helping to keep them neatly inside the footwear and not squished, overlapping, or falling out from the footwear.

According to one aspect of the invention, the devices, systems, methods, and/or computer readable media may preferably, but need not necessarily, help to stop “toe crush” and/or “toe spilling” at the toe box area of the user's footwear.

According to one aspect of the invention, the soles and/or insoles may preferably, but need not necessarily, be infused with one or more blends of eucalyptus oils and/or silver ions, preferably helping to lend them substantial antifungal, antibacterial, sweat-proof, and/or stink-proof characteristics.

According to the invention, there is also disclosed a method and/or computer-readable medium for manufacturing a custom orthotic sole device for a user, customized to the user's feet and/or footwear. The method may preferably include step (a) of performing a three-dimensional (“3D”) foot scan of unique anatomical features of the user's feet. The method may preferably include step (b) of performing a 3D footwear scan of the footwear. The 3D footwear scan may preferably include a slope line and/or pitch of the footwear. And/or, the method may preferably include step (c) of shaping the custom orthotic sole device, preferably in dependent relation based on the three-dimensional (“3D”) foot scan and/or the 3D footwear scan, and/or preferably to match the unique anatomical features (which may be alternately referred to herein as the “unique anatomy”) of the user's feet with the slope line and/or pitch of the footwear. The custom orthotic sole device may preferably be further shaped to define one or more of the following orthotic sole features: (i) a sunken heel portion (alternately referred to herein as a heel cup portion), preferably to help counter-shift a weight of the user backwards and/or to help realign a heel (which may be alternately referred to herein as “to help align a calcaneus”) of the user; (ii) a stopper portion, substantially adjacent to and/or after the heel cup portion, preferably to engage and/or support a calcaneus of the user and/or to help stop the calcaneus from sliding downward in the footwear; (iii) an arch portion, which may preferably be raised to a predetermined degree, preferably to help stabilize a posture of the user's feet in the footwear and/or to help reinforce and/or stop the user's foot from sliding downward in the footwear; (iv) metatarsal pads, which may preferably be shaped to a predetermined height and/or with a predetermined durometer and hardness, preferably to help support the weight of the user, to help with a predetermined shift of metatarsal heads of the user's feet, and/or to help with a predetermined splay of toes of the user's feet; (v) a bunion cut out shape, preferably to help to offload a bunion area of the user, and/or to help reduce pressure on a forefoot of the user; and/or (vi) a built-in toe crest portion, preferably to help space and/or divide the toes of the user, to help keep the toes inside the footwear, and/or to help prevent the toes from becoming squished, overlapping, and/or falling out from the footwear. The method and the custom orthotic sole device may preferably be adapted to help provide for redistribution of the weight of the user away from the forefoot of the user by combination of the aforesaid orthotic sole features. According to the invention, step (c) may preferably be performed in dependent relation based on one or more of the following medical assessment components: a total body alignment of the user; a posture of the user; a gait of the user; any leg length discrepancy of the user; any limited range of motion of the user; any pelvic tilt of the user; and a substantially precise measured degree of any misalignment of the user. In step (c), the custom orthotic sole device may preferably be automatically 3D printed and/or milled via computer numerical control (“CNC”) software on a computer readable medium operatively connected to a 3D printer and/or a milling machine. The method and/or the custom orthotic sole device may preferably be adapted for use with, and/or to fit, a wide range of feet and/or footwear. The method and/or the custom orthotic sole device may preferably be adapted to help avoid toe crush and/or toe spilling of the toes of the user at a toe box area of the footwear. The custom orthotic sole device may preferably be infused with a blend of eucalyptus oils and/or silver ions, to lend substantial antifungal, antibacterial, sweat-proof, and/or stink-proof characteristics.

According to the invention, there is also disclosed a method and/or computer-readable medium for manufacturing a custom orthotic sole device for a user, customized to the user's feet and footwear. The method may preferably include step (a) of performing a three-dimensional (“3D”) foot scan of unique anatomical features of the user's feet. And/or, the method may preferably include step (b) of shaping the custom orthotic sole device, preferably in dependent relation based on the three-dimensional (“3D”) foot scan, and/or preferably to match the unique anatomical features of the user's feet. The custom orthotic sole device may preferably be further shaped to define one or more orthotic sole features.

According to one aspect of the invention, the method may preferably, but need not necessarily, also include step (a.1) of performing a 3D footwear scan of the footwear. The 3D footwear scan may preferably, but need not necessarily, include a slope line and/or pitch of the footwear. Preferably in step (b), the custom orthotic sole device may preferably, but need not necessarily, also be shaped in dependent relation based on the 3D footwear scan. The unique anatomical features of the user's feet may preferably, but need not necessarily, be matched with the slope line and/or pitch of the footwear.

According to one aspect of the invention, the orthotic sole features may preferably, but need not necessarily, include at least one of the following: (i) a sunken heel portion (alternately referred to herein as a heel cup portion), preferably to help counter-shift a weight of the user backwards and/or to help realign a heel of the user; (ii) a stopper portion, preferably substantially adjacent to and/or after the heel cup portion, and/or preferably to engage and/or support a calcaneus of the user and/or to help stop the calcaneus from sliding downward in the footwear; (iii) an arch portion, which may preferably, but need not necessarily, be raised to a predetermined degree, preferably to help stabilize a posture of the user's feet in the footwear and/or to help reinforce and stop the user's foot from sliding downward in the footwear; (iv) metatarsal pads, which may preferably, but need not necessarily, be shaped to a predetermined height and/or with a predetermined durometer and/or hardness, preferably to help support the weight of the user, to help with a predetermined shift of metatarsal heads of the user's feet, and/or to help with a predetermined splay of toes of the user's feet; (v) a bunion cut out shape, preferably to help to offload a bunion area of the user, and/or to help reduce pressure on a forefoot of the user; and/or (vi) a built-in toe crest portion, preferably to help space and/or divide the toes of the user, to help keep the toes inside the footwear, and/or to help prevent the toes from becoming squished, overlapping, and/or falling out from the footwear.

According to one aspect of the invention, a combination of the orthotic sole features may preferably, but need not necessarily, be adapted to help provide for redistribution of the weight of the user, preferably away from the forefoot of the user.

According to one aspect of the invention, step (b) may preferably, but need not necessarily, be performed in dependent relation based on at least one of the following medical assessment components: a total body alignment of the user; a posture of the user; a gait of the user; any leg length discrepancy of the user; any limited range of motion of the user; any pelvic tilt of the user; and/or a substantially precise measured degree of any misalignment of the user.

According to one aspect of the invention, in step (b), the custom orthotic sole device may preferably, but need not necessarily, be automatically 3D printed via computer numerical control (“CNC”) software on a computer readable medium operatively connected to a 3D printer.

According to one aspect of the invention, in step (b), the custom orthotic sole device may preferably, but need not necessarily, be automatically milled via computer numerical control (“CNC”) software on a computer readable medium operatively connected to a milling machine.

According to one aspect of the invention, the method and/or the custom orthotic sole device may preferably, but need not necessarily, be adapted for use with, and/or to fit, a wide range of feet and/or footwear.

According to one aspect of the invention, the method and/or the custom orthotic sole device may preferably, but need not necessarily, be adapted to help avoid toe crush and/or toe spilling of the toes of the user at a toe box area of the footwear.

According to one aspect of the invention, the custom orthotic sole device may preferably, but need not necessarily, be infused with a blend of eucalyptus oils and/or silver ions, preferably to lend substantial antifungal, antibacterial, sweat-proof, and/or stink-proof characteristics.

According to the invention, there is also disclosed a custom orthotic sole device for a user, customized to the user's feet and footwear. The device may preferably be manufactured using a three-dimensional (“3D”) foot scan of unique anatomical features of the user's feet. The device may preferably be shaped, preferably in dependent relation based on the three-dimensional (“3D”) foot scan, and/or preferably to match the unique anatomical features of the user's feet. The custom orthotic sole device may preferably be further shaped to define one or more orthotic sole features.

According to one aspect of the invention, the device may preferably, but need not necessarily, also be manufactured using a 3D footwear scan of the footwear that preferably includes a slope line and/or pitch of the footwear. The device may preferably, but need not necessarily, also be shaped: in dependent relation based on the 3D footwear scan; and/or such that the unique anatomical features of the user's feet may preferably, but need not necessarily, be matched with the slope line and/or pitch of the footwear.

According to one aspect of the invention, the orthotic sole features may preferably, but need not necessarily, include: (i) a sunken heel portion (alternately referred to herein as a heel cup portion) preferably to help counter-shift a weight of the user backwards and/or to help realign a heel of the user; (ii) a stopper portion, preferably substantially adjacent to and/or after the heel cup portion, and/or preferably to engage and/or support a calcaneus of the user and/or to help stop the calcaneus from sliding downward in the footwear; (iii) an arch portion, which may preferably, but need not necessarily, be raised to a predetermined degree, preferably to help stabilize a posture of the user's feet in the footwear and/or to help reinforce and/or stop the user's foot from sliding downward in the footwear; (iv) metatarsal pads, which may preferably, but need not necessarily, be shaped to a predetermined height and/or with a predetermined durometer and/or hardness, preferably to help support the weight of the user, to help achieve any predetermined shift of metatarsal heads of the user's feet, and/or to help achieve any predetermined splay of toes of the user's feet; (v) a bunion cut out shape, preferably to help offload a bunion area of the user, and/or to help reduce pressure on a forefoot of the user; and/or (vi) a built-in toe crest portion, preferably to help space and/or divide the toes of the user, to help keep the toes inside the footwear, and to/or help prevent the toes from becoming squished, overlapping, and/or falling out from the footwear.

According to the invention, there is also disclosed a computer-readable medium encoded with executable computer processing instructions to, when operatively executed by one or more computer processors, preferably perform any of the methods above, and/or manufacture any of the devices above.

The devices, systems, methods, and/or computer readable media according to the invention may preferably, but need not necessarily, be adapted to include and/or provide for one or more features and/or functionalities as illustrated in accompanying FIGS. 1 to 7.

Persons skilled in the art will appreciate, in view of the teachings and disclosures herein, that the devices, systems, methods, and/or computer readable media according to the invention may offer significant advantageous utilities and/or functionality in comparison to prior art.

Other advantages, features, and/or characteristics of the present invention, as well as methods of operation and functions of the related elements of the structure, operation, and/or the combination of parts, features, and/or economies of manufacture, will become more apparent upon consideration of this detailed description with reference to the figures which accompany this application.

### BRIEF DESCRIPTION OF THE DRAWINGS

The novel features which are believed to be characteristic of the present invention, and related devices, systems, methods, and/or computer readable media according to the present invention, as to their structure, organization, use, and/or methods of manufacture and/or operation, together with further objectives and advantages thereof, may be better understood from the figures which accompany this application, in which presently preferred embodiments of the invention have been illustrated by way of example. It is expressly understood, however, that such figures have been provided for the purpose of illustration and/or description only, and not intended as a definition of the limits of the invention. In the accompanying figures:

FIG. 1 is a side perspective view a prior art orthotic insole;

FIG. 2 is a side perspective view of a foot, showing a number of foot conditions to be prevented and/or corrected;

FIG. 3 is a side perspective view of a prior art high heel shoe;

FIG. 4 is a top side perspective view of an orthotic insole device according to a preferred embodiment of the invention;

FIG. 5 is a top plan view of the orthotic insole device of FIG. 4;

FIG. 6 is a bottom plan view of the orthotic insole device of FIG. 4; and

FIG. 7 is a side perspective view of the orthotic insole device of FIG. 4, shown with both a user's foot and high heel footwear in phantom outline.

### DETAILED DESCRIPTION OF PREFERRED EMBODIMENTS

This disclosure, including the accompanying drawings, may include one or more numbers, words, phrases, sentences, arrangements, and/or configurations which may be included by way of example. It may bear repeating, in this respect specifically, that such drawings and/or this disclosure are for the purpose of illustration and description only, and not intended as a definition of the limits of the invention.

The accompanying drawings illustrate aspects of one or more orthotic insole devices according to preferred embodiments of the invention.

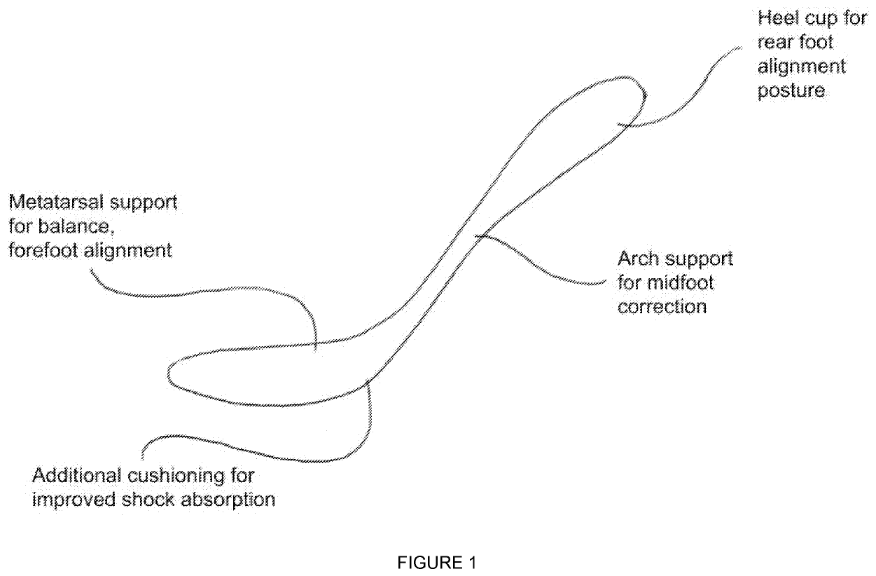

FIG. 1 depicts a prior art orthotic insole with a heel cup for rear foot alignment and posture, an arch support for midfoot correction, a metatarsal support for balance and forefoot alignment, and additional cushioning for improved shock absorption.

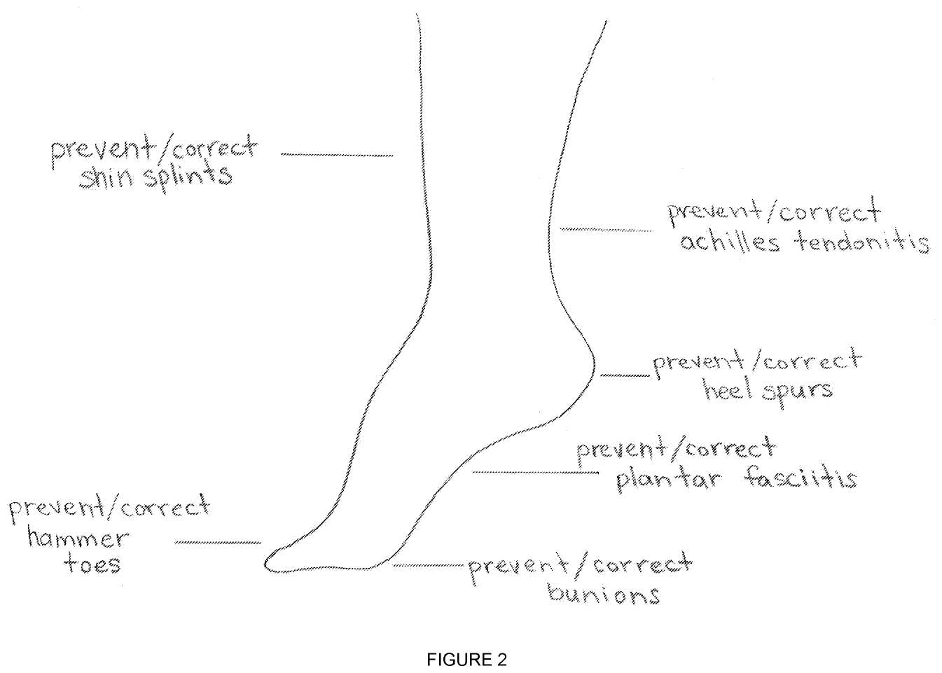

FIG. 2 depicts a foot and a number of foot conditions which may desirably be biomechanically prevented and/or corrected, including shin splints, hammer toes, bunions, plantar fasciitis, heel spurs, and achilles tendonitis.

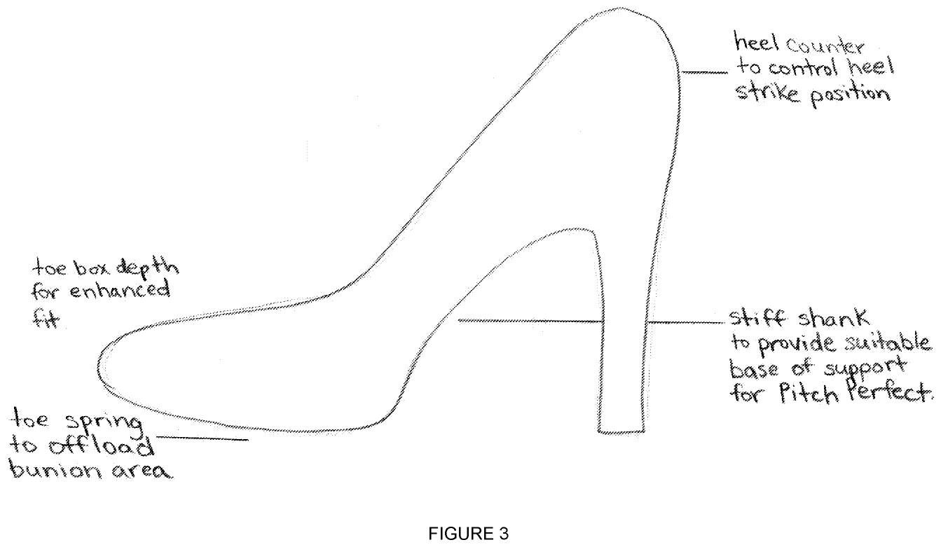

FIG. 3 depicts a high heel shoe having the following structural features: a heel counter portion to help control a heel's strike position, a stiff shank portion to help provide a suitable base of support for an orthotic insole, a toe spring portion to help offload a bunion area, and a toe box depth portion for an enhanced fit.

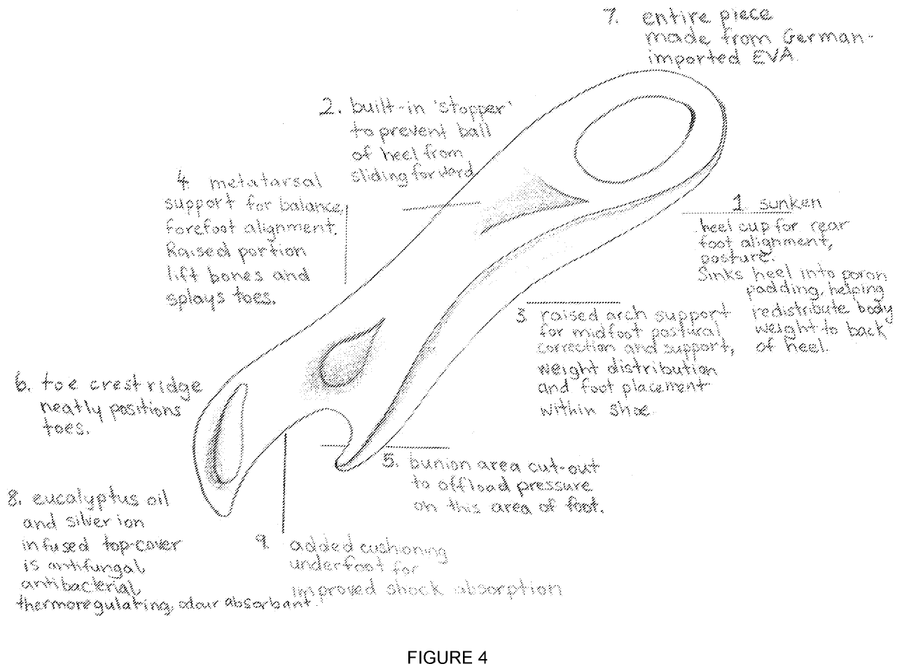

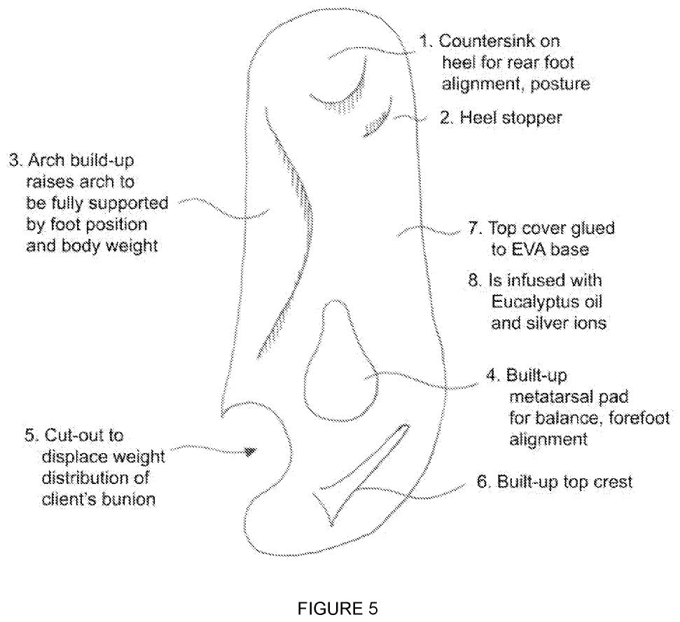

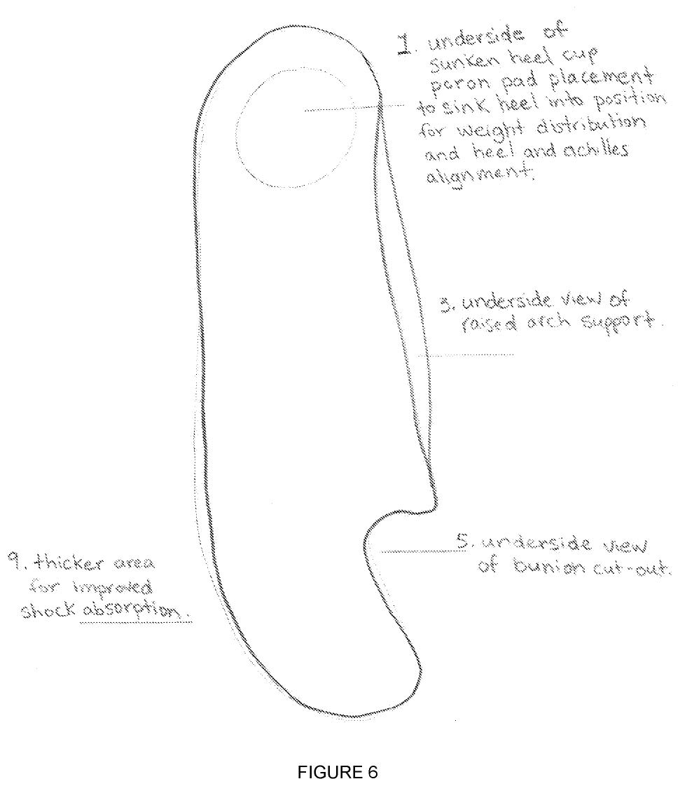

FIGS. 4 to 7 depict an orthotic insole device according to a preferred embodiment of the invention. (The orthotic insole device shown in FIGS. 4 to 7 is for a left foot. Naturally it will be understood that the invention also encompasses orthotic insole devices for right feet, and persons having ordinary skill in the art may readily appreciate that they may be a mirror image of the orthotic insole device shown in FIGS. 4 to 7.) FIG. 4 is a top right perspective view, FIG. 5 is a top view, and FIG. 6 is a bottom view of the orthotic insole device according to a preferred embodiment of the invention.

As shown in FIGS. 4 to 6, the orthotic insole device according to the invention is preferably shaped with:
(1) A countersink or sunken area on the heel portion of the insole. It is preferably displaced with a padding material which is preferably formed from a microporous plastic material (e.g., a Poron™ material as may be offered by Rogers Corporation of Chandler, Ariz.) that affords thermal insulation characteristics. The countersink area preferably enables a user's heel to sink into a cupped position therein. It preferably helps with rear foot alignment and posture or helps to redistribute the user's weight to a back portion of the heel.
(2) A built-in heel stopper portion, which preferably (in a new and ingenious way) helps to prevent the ball of the user's heel from sliding forward.
(3) A built-up arch profile portion, which preferably helps raise and fully support the arch of the user's foot, preferably by foot position and body weight. It preferably helps to redistribute the foot's weight and position in the shoe.
(4) A built-up metatarsal head pad portion, which preferably helps to lift the bones of the user's foot and to splay its toes. It preferably also helps with balance and forefoot alignment.
(5) A bunion cut-out portion, which preferably helps displace weight distribution of a user's bunion. The bunion cutout portion is preferably for the user's first metatarsal-phalangeal joint and effectively assists in mechanical loading through the forefoot. And,
(6) A toe crest portion, which preferably helps to neatly position and space the toes of the user's foot.

Also, as shown in FIGS. 4 to 6, the orthotic insole device includes:
(7) A base portion, which is preferably formed from a closed cell ethylene-vinyl acetate (“EVA”) copolymer foam material, or from a renewable source used in additive manufacturing. The base portion is preferably shaped with features (1) to (6) above and with feature (9) below. The EVA base portion is preferably CNC milled (or 3D printed) using digital computer-aided design/computer-aided manufacturing (“CAD/CAM”) computer systems, which may preferably be used to design and/or control manufacture processes for the EVA base portion. (As an aside, it may be worthwhile to specifically note here that preferred embodiments of the invention need not necessarily be limited to CNC milling and/or 3D printing manufacturing processes.) And,
(8) A top-cover portion, which is preferably glued to the EVA base portion. the top-cover portion is preferably infused with one or more eucalyptus oils and silver ions preferably to afford antifungal and antibacterial properties, and to help make the top-cover thermoregulated and substantially odour free. The top-cover portion preferably also provides enhanced grip for a user's barefoot, and further improves the device's ability to prevent the user's foot from sliding forward.

As best seen in FIGS. 4 and 5, the orthotic insole device is preferably also shaped with:
(9) An additional cushioning portion, which preferably affords improved shock absorption.

According to preferred embodiments of the invention, the devices, systems, methods, and/or computer readable media are preferably adapted for use in combination with assessment of related medical factors and the user's weight and height. The systems, methods, and/or computer readable media according to preferred embodiments of the invention involve and/or provide for precise measurement (e.g., sub-millimeter dimensions and measurements) of the user's feet and high heel footwear which are preferably taken by 3D scan or photogrammetry. The orthotic insoles according to the invention are preferably medically designed to change biomechanical weight distribution and position, and total body alignment.

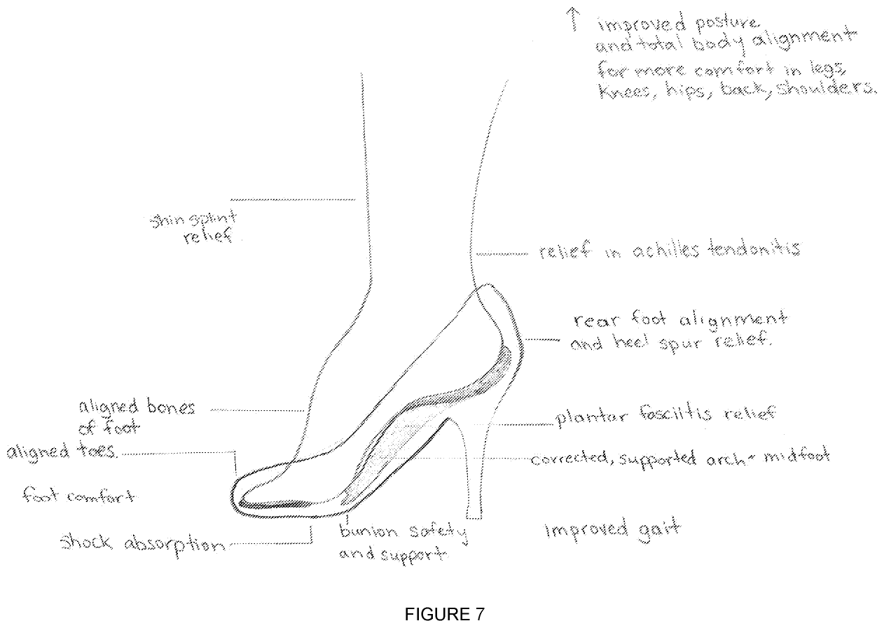

FIG. 7 shows the orthotic insole device according to a preferred embodiment of the invention, with a user's foot, inside high heel footwear. In use, the invention preferably helps to eliminate shin splints, achilles tendonitis, heel spurs, and plantar fasciitis, helps to align the bones of the user's foot and the user's rear foot, and helps provide foot comfort, shock absorption, improved gait, bunion safety and support, and a corrected and supported arch and midfoot. Additionally, use of the invention preferably helps provide better posture and total body alignment, and more comfort in the user's legs, knees, hips, back, and shoulders.

Substantially precise and/or exact dimensions, measurements, specs, and/or other information—including 3D scans of the user's feet in weight-bearing and/or neutrally corrected (calcaneal vertical, sub-talar neutral, with rearfoot and forefoot neutrally positioned to the user's anatomical alignment) non-weight bearing configurations—are preferably transferred digitally for manufacture of the insoles according to the invention. In manufacturing methods, according to the invention, this information is preferably imported to CAD/CAM software on computer readable media to prepare it for output to a CNC milling machine, additive manufacturing/3D printing, and/or other system.

The insole base portion is preferably milled, from an EVA block, using a CNC milling machine, or from a renewable source used in additive manufacturing, and/or other system according to the invention. According to the invention, the EVA blocks may preferably have standard dimensions of about 5.5 inches, by about 1.25 inches, by about 13.25 inches. The EVA blocks preferably have a Shore Type A or Type OO durometer hardness in the range of between about 30 and about 50. (The scope of the present invention extends to encompass, instead or in addition, 3D printing of the base portion from EVA or another material.)

After milling, the blocks are preferably shaped as insoles and/or hand-finished with a top-cover portion that is preferably applied and secured thereto by a manual gluing process. (The scope of the present invention extends to encompass, instead or in addition, applying the top-cover to the base portion by an automated gluing process.)

The top-cover portion for each insole is preferably formed from pre-cut pieces and/or a roll of top-cover material. One or more logos may be pre-printed (e.g., in a zinc-coloured ink) on the top-cover material. The top-cover material preferably has antibacterial properties. It is preferably embedded with silver ions, and is preferably breathable, with an absorption capacity of preferably about 8 times its weight in water. The top-cover material preferably affords comfort and dryness properties with its thermo-regulating effect as aforesaid. It is preferably substantially abrasion, tear, and/or rip resistant under both dry and humid (or wet) conditions. The top-cover material may preferably be embedded with a natural Eucalyptus aroma, and preferably keeps its aroma when washed in temperatures of up to about 30° C. It is preferably anti-allergic and does not generate odors. The top-cover material preferably has a thickness of about 0.75 millimeters. It is preferably relatively light, flexible, and comfortable (as compared, for example, with pigskin). The top-cover material is grindable and can be readily worked with. It is similar to real leather but with increased strength.

The top cover portion preferably, in addition to helping the foot breathe, provides a high grip surface that may help keep the foot from sliding forward inside the user's high heel footwear.

After manufacture, finished orthotic insole devices according to the invention may preferably be fit on the user's foot and in specific footwear, and minor adjustments may be performed if necessary.

Accordingly, some features, elements, parts and/or steps that preferably work together according to (or in association with) the invention may include a medical assessment of the user's needs, 3D scans, correct and/or appropriate footwear, digital design and manufacture of an orthotic insole device, and a professional fitting. Some of the invention's features, elements, parts, steps, and/or sub-combinations thereof may be altogether new, including the built-in heel stopper, the sunken heel cup, and one or more combinations of features, including the EVA base portion and the top cover portion, along with a medical assessment, digital design and manufacture, and dispensing.

In use, some advantages of the invention, over the prior art, may include one or more of the following: (a) its utility in obviating or mitigating one or more disadvantages or shortcomings associated with the prior art, in meeting or providing for one or more desires, benefits, needs or advantages, or in achieving one or more objects of the invention; (b) its customization and tailoring to each particular user, preferably being moulded to the unique shape of their foot; (c) its custom fit to specific footwear; (d) its compliance and adherence to medically sound principles of design and use; (e) its coverage of the entire foot; and/or (f) its ability for transfer to other (similar structure) high heel footwear.

The EVA and Poron™ materials, according to the invention, preferably afford significant comfort advantages for the user's foot and substantially/readily conform to the shape of the user's shoe pitch and slope line, with an ability to accommodate minor nuances.

The 3D scans, according to the invention, are preferably highly accurate.

One or more features and functionalities of the invention are preferably offered under or in association with the applicant's distinctive PITCH PERFECT trademark.

The invention is contemplated for use by or in association with insoles, soles, and footwear. The invention, however, is not so limited. Other embodiments, which fall within the scope of the invention, may be provided. For example, the invention encompasses full 3D prints of high heel footwear (or any portions thereof) complete with one or more of the aforementioned features of the invention

Preferably, devices, apps, systems, methods, and/or computer readable media according to the invention may be used for, and afford advantageous utilities with, industries and/or user environments other than those associated with insoles, soles, and/or footwear.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations and/or steps according to the invention are not specifically referenced in the accompanying drawings or in association with one another, they may be used, and/or adapted for use, in association therewith. For example, features may be depicted or discussed herein in the context of the device, which clearly could be recast as the steps of a method, the inter-workings of a system, and/or recorded on computer readable media. (And, vice-versa.) All of the depicted and aforementioned and various other features, steps, inter-workings, structures, configurations, relationships, utilities, and/or the like (any of which may be depicted and/or based hereon) may be, but are not necessarily, incorporated into and/or achieved by the invention. Any one or more of the depicted and aforementioned features, steps, inter-workings, structures, configurations, relationships, utilities and the like may be implemented in and/or by the invention, on their own, and/or without reference, regard or likewise implementation of any of the other depicted or aforementioned features, steps, inter-workings, structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of this patent application.

1. A method and computer-readable medium for manufacturing a custom orthotic sole device for a user, customized to the user's feet and footwear, the method comprising steps of:
(a) performing a three-dimensional (“3D”) foot scan of unique anatomical features of the user's feet;
(b) performing a 3D footwear scan of the footwear, wherein the 3D footwear scan comprises a slope line and pitch of the footwear; and
(c) shaping the custom orthotic sole device, in dependent relation based on the three-dimensional (“3D”) foot scan and the 3D footwear scan, to match the unique anatomical features of the user's feet with the slope line and pitch of the footwear; wherein the custom orthotic sole device is further shaped to define one or more of the following orthotic sole features:
(i) a sunken heel portion (alternately referred to herein as a heel cup portion) to help counter-shift a weight of the user backwards and to help realign a heel of the user;
(ii) a stopper portion, substantially adjacent to and after the heel cup portion, to engage and support a calcaneus of the user and to help stop the calcaneus from sliding downward in the footwear;
(iii) an arch portion, which is raised to a predetermined degree, to help stabilize a posture of the user's feet in the footwear and to help reinforce and stop the user's foot from sliding downward in the footwear;
(iv) metatarsal pads, which are shaped to a predetermined height and with a predetermined durometer and hardness, to help support the weight of the user, to help with a predetermined shift of metatarsal heads of the user's feet, and to help with a predetermined splay of toes of the user's feet;
(v) a bunion cut out shape to help to offload a bunion area of the user, and to help reduce pressure on a forefoot of the user; and
(vi) a built-in toe crest portion to help space and divide the toes of the user, to help keep the toes inside the footwear, and to help prevent the toes from becoming squished, overlapping, or falling out from the footwear;
wherein the method and the custom orthotic sole device are adapted to help provide for redistribution of the weight of the user away from the forefoot of the user by combination of at least two of said orthotic sole features;
wherein step (c) is performed in dependent relation based on at least one of the following medical assessment components: a total body alignment of the user; a posture of the user; a gait of the user; any leg length discrepancy of the user; any limited range of motion of the user; any pelvic tilt of the user; and a substantially precise measured degree of any misalignment of the user;
wherein, in step (c), the custom orthotic sole device is automatically 3D printed or milled via computer numerical control (“CNC”) software on a computer readable medium operatively connected to a 3D printer or a milling machine;
wherein the method and the custom orthotic sole device are adapted for use with, and to fit, a wide range of feet and footwear;
wherein the method and the custom orthotic sole device are adapted to help avoid toe crush and toe spilling of the toes of the user at a toe box area of the footwear; and
wherein the custom orthotic sole device is infused with a blend of eucalyptus oils and/or silver ions, to lend substantial antifungal, antibacterial, sweat-proof, and/or stink-proof characteristics.

2. A method and computer-readable medium for manufacturing a custom orthotic sole device for a user, customized to the user's feet and footwear, the method comprising steps of:
(a) performing a three-dimensional (“3D”) foot scan of unique anatomical features of the user's feet; and
(b) shaping the custom orthotic sole device, in dependent relation based on the three-dimensional (“3D”) foot scan, to match the unique anatomical features of the user's feet; and wherein the custom orthotic sole device is further shaped to define one or more orthotic sole features.

3. The method of claim 2 further comprising the step of (a.1) performing a 3D footwear scan of the footwear, wherein the 3D footwear scan comprises a slope line and pitch of the footwear; and wherein, in step (b), the custom orthotic sole device is also shaped in dependent relation based on the 3D footwear scan, and the unique anatomical features of the user's feet are matched with the slope line and pitch of the footwear.

4. The method of claim 3, wherein the orthotic sole features comprise at least one of the following:
(i) a sunken heel portion (alternately referred to herein as a heel cup portion) to help counter-shift a weight of the user backwards and/or to help realign a heel of the user;
(ii) a stopper portion, substantially adjacent to and after the heel cup portion, to engage and/or support a calcaneus of the user and/or to help stop the calcaneus from sliding downward in the footwear;
(iii) an arch portion, which is raised to a predetermined degree, to help stabilize a posture of the user's feet in the footwear and to help reinforce and stop the user's foot from sliding downward in the footwear;
(iv) metatarsal pads, which are shaped to a predetermined height and with a predetermined durometer and hardness, to help support the weight of the user, to help with a predetermined shift of metatarsal heads of the user's feet, and/or to help with a predetermined splay of toes of the user's feet;
(v) a bunion cut out shape to help to offload a bunion area of the user, and/or to help reduce pressure on a forefoot of the user; and
(vi) a built-in toe crest portion to help space and divide the toes of the user, to help keep the toes inside the footwear, and/or to help prevent the toes from becoming squished, overlapping, or falling out from the footwear.

5. The method of claim 4, wherein a combination of the orthotic sole features is adapted to help provide for redistribution of the weight of the user away from the forefoot of the user.

6. The method of claim 5, wherein step (b) is performed in dependent relation based on at least one of the following medical assessment components: a total body alignment of the user; a posture of the user; a gait of the user; any leg length discrepancy of the user; any limited range of motion of the user; any pelvic tilt of the user; and a substantially precise measured degree of any misalignment of the user.

7. The method of claim 6 wherein, in step (b), the custom orthotic sole device is automatically 3D printed via computer numerical control (“CNC”) software on a computer readable medium operatively connected to a 3D printer.

8. The method of claim 6 wherein, in step (b), the custom orthotic sole device is automatically milled via computer numerical control (“CNC”) software on a computer readable medium operatively connected to a milling machine.

9. The method of claim 8, wherein the method and the custom orthotic sole device are adapted for use with, and/or to fit, a wide range of feet and footwear.

10. The method of claim 9, wherein the method and the custom orthotic sole device are adapted to help avoid toe crush and/or toe spilling of the toes of the user at a toe box area of the footwear.

11. The method of claim 10, wherein the custom orthotic sole device is infused with a blend of eucalyptus oils and/or silver ions, to lend substantial antifungal, antibacterial, sweat-proof, and/or stink-proof characteristics.

12. A custom orthotic sole device for a user, customized to the user's feet and footwear, wherein the device is manufactured using a three-dimensional (“3D”) foot scan of unique anatomical features of the user's feet; wherein the device is shaped, in dependent relation based on the three-dimensional (“3D”) foot scan, to match the unique anatomical features of the user's feet; and wherein the custom orthotic sole device is further shaped to define one or more orthotic sole features.

13. The device of claim 12, wherein the device is also manufactured using a 3D footwear scan of the footwear that comprises a slope line and pitch of the footwear; and wherein the device is also shaped: in dependent relation based on the 3D footwear scan; and such that the unique anatomical features of the user's feet are matched with the slope line and pitch of the footwear.

14. The device of claim 13, wherein the orthotic sole features comprise:
(i) a sunken heel portion (alternately referred to herein as a heel cup portion) to help counter-shift a weight of the user backwards and to help realign a heel of the user.

15. The device of claim 14, wherein the orthotic sole features further comprise:
(ii) a stopper portion, substantially adjacent to and after the heel cup portion, to engage and support a calcaneus of the user and to help stop the calcaneus from sliding downward in the footwear.

16. The device of claim 15, wherein the orthotic sole features further comprise:
(iii) an arch portion, which is raised to a predetermined degree, to help stabilize a posture of the user's feet in the footwear and to help reinforce and stop the user's foot from sliding downward in the footwear; and
(iv) metatarsal pads, which are shaped to a predetermined height and with a predetermined durometer and hardness, to help support the weight of the user, to help achieve any predetermined shift of metatarsal heads of the user's feet, and to help achieve any predetermined splay of toes of the user's feet.

17. The device of claim 16, wherein the orthotic sole features further comprise:
(v) a bunion cut out shape to help to offload a bunion area of the user, and to help reduce pressure on a forefoot of the user; and
(vi) a built-in toe crest portion to help space and divide the toes of the user, to help keep the toes inside the footwear, and to help prevent the toes from becoming squished, overlapping, or falling out from the footwear.

18. The device of claim 17, wherein a combination of the orthotic sole features is adapted to help provide for redistribution of the weight of the user away from the forefoot of the user.

19. The device of claim 18 further adapted to help avoid toe crush and/or toe spilling of the toes of the user at a toe box area of the footwear.

20. The device of claim 19 infused with a blend of eucalyptus oils and/or silver ions, to lend substantial antifungal, antibacterial, sweat-proof, and/or stink-proof characteristics.
